(19) United States
(12) Patent Application Publication
(10) Pub. No.: US 2009/0200864 A1
(43) Pub. Date: Aug. 13, 2009

(54) CHIP ON BUS BAR

(76) Inventor: Josef Maier, Munningen (DE)

Correspondence Address: CARLSON, GASKEY & OLDS, P.C., 400 WEST MAPLE ROAD, SUITE 350, BIRMINGHAM, MI, 48009, US

(21) Appl. No.: 12/029,679

(22) Filed: Feb. 12, 2008

(51) Int. Cl. B60L 1/00; H02G 5/00

(52) U.S. Cl. 307/9.1; 174/68.2

(57) ABSTRACT

A bus bar assembly for a power distribution system is disclosed that includes first and second bus bars electrically isolated from one another. The bus bars are interconnected by a semiconductor switching element that is mounted on at least one of the first and second bus bars. In one example, the semiconductor switching element is a bare die that is secured directly to one of the first and second bus bars, for example, by a copper pad. A driver logic control device is in communication with the semiconductor switching element. The driver logic control device is configured to drive the semiconductor to electrically connect the first and second bus bars in response to a command to provide power to an aircraft component, such as a secondary power distribution box.

### BACKGROUND

This disclosure relates to bus bar switching devices used in high current aircraft power distribution systems.

In typical primary (or high current) aircraft electrical power distribution systems, the power is fed to the distribution boxes/panels by heavy gauge wires. These wires are bolted onto a terminal block, which connects to the box internal bus bars. The bus bars are typically heavy aluminum or copper strips that are formed to a desired shape for easy installation and smallest space consumption. The bus bars also must be segregated from one another.

Electromechanical contactors including diagnostics and protection functions (sometimes referred to as “smart contactors”) toe-switch the power provided by these bus bars between one another. The electromechanical contactors are bolted onto the bus bars at their input terminals. The output terminals of the electromechanical contactors are bolted to the next bus bar dedicated for the output of the power.

The electromechanical contactors are large, heavy and costly. They wear out, requiring replacement, which can be difficult when located in spaces difficult to access. What is needed is a power distribution system and switching device that is light, cost effective and capable of handling high currents.

### SUMMARY

A bus bar assembly for a power distribution system is disclosed that includes first and second bus bars electrically isolated from one another. The bus bars are interconnected by a semiconductor switching element that is mounted on at least one of the first and second bus bars. A driver logic control device is in communication with the semiconductor switching element. The driver logic control device is configured to electrically connect the first and second bus bars in response to a command to provide power to an aircraft component, such as a secondary power distribution box.

These and other features of the application can be best understood from the following specification and drawings, the following of which is a brief description.

### BRIEF DESCRIPTION OF THE DRAWINGS

FIG. 1 is a schematic view of a power distribution system including bus bars having a semiconductor switching element.

FIG. 2 is a schematic view a power distribution box shown in FIG. 1 illustrating a MOSFET and driver logic control device.

FIG. 3 is an enlarged cross-sectional view of the semiconductor switching element mounted on a bus bar.

### DETAILED DESCRIPTION

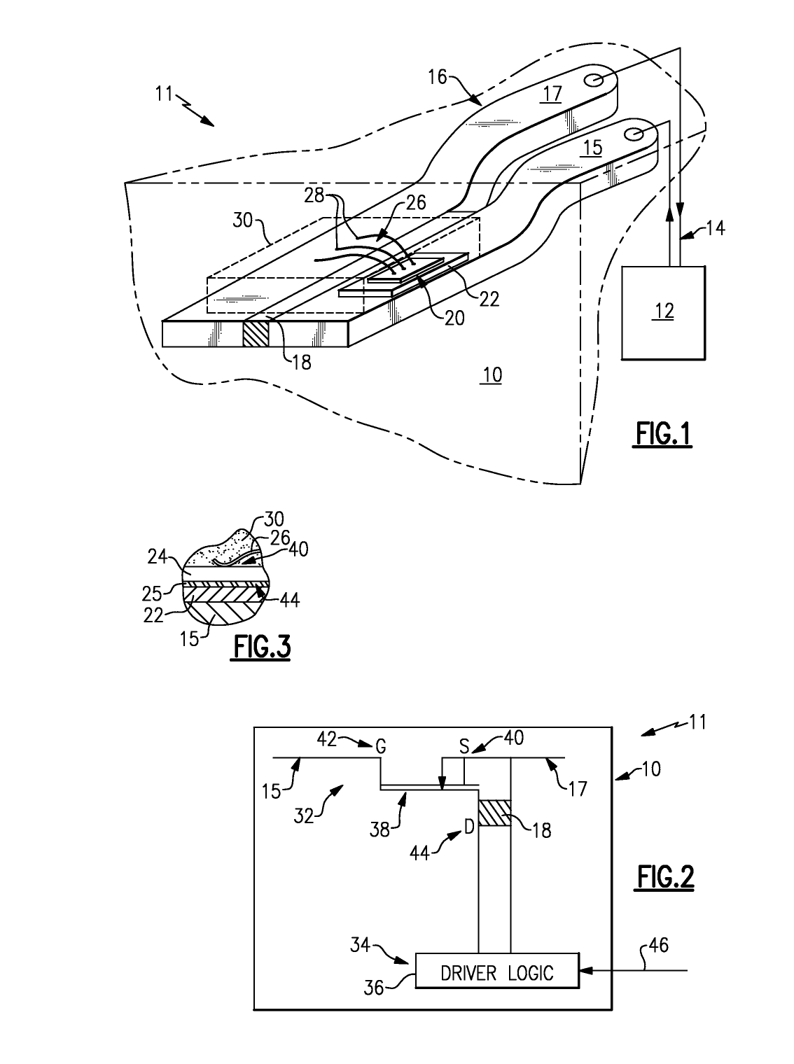

An aircraft power distribution system 11 is shown in FIG. 1. The system 11 includes a power distribution box 10 that houses bus bars 16. The bus bars 16 are interconnected by wires 14 to an aircraft component 12, such as a generator or secondary power distribution box. The bus bars 16 can be used in AC and DC applications, including high voltage DC applications. The bus bars 16 include first and second bus bars 15, 17 that correspond to input and output bus bars, for example. An isolator 18 is arranged between the first and second bus bars 15, 17 to electrically insulate the first and second bus bars 15, 17 from one another.

The mechanical contactors typically used between the first and second bus bars 15, 17 are replaced with a semiconductor switching element 20. In one example, power MOSFETs 38 are used, as schematically shown in FIG. 2. The number and type of MOSFETs 38 depends on the current and voltage rating of the MOSFET and the particular application. The source 40, gate 42 and drain 44 connections are schematically shown. TRIACs, IGTBs and SCRs can also be used as the semiconductor switching elements 20.

The semiconductor switching element 20 is assembled into a package that can be electrically connected to the first and second bus bars 15, 17. For example, one type of package is SMT style, which can be assembled onto a PCB. The PCB can then be mounted onto or plugged into the bus bars 16. For improved weight and volume reduction in aircraft applications, bare dies could be assembled directly onto the PCB. However, for high current applications it is difficult to feed the current through a connector from the bus bars 16 to the PCB and it is also difficult to manage this current within the PCB due to the needed high copper content. In general, the copper and connector losses on the PCB cause a significant cooling challenge.

Rather than placing the bare pins on a dedicated PCB or module that plugs into one of the bus bars 16, the bare dies 24 are attached directly onto the first bus bar 15, for example. In this manner, losses from the connections associated with such a PCB arrangement can be eliminated. The dies 24 can be attached using solder 25 (FIG. 3), or similar connections, such as epoxy. In one example, the first bus bar 15 is aluminum. A copper pad 22 is secured to the first bus bar 15, and the dies 24 are secured to the copper pad 22.

Returning to FIG. 1, the electrical connection from the dies 24 to the second bus bar side 17 is achieved by wiring 26 using wire bonding or a similar approach, like ribbon bonds 28. Potting material 30 is used to protect the semiconductor switching element 20 and wiring 26 using dam and fill technology, or a similar approach. The dies 24 on the first bus bar 15 are cooled by the conductive/convectional cooling that the bus bar itself provides.

A driver logic control device 36 communicates with the semiconductor switching element 20. The driver logic control device 36 drives the dies 24 to electrically connect the first and second bus bars 15, 17 to one another in response to a command 46. In one example, the semiconductor switching element 20 and the driver logic control device 36 are both located within the power distribution box 10 but at locations 32, 34 that are remote from one another. In this manner, the driver logic control device 36 can be positioned in a more accessible location than the semiconductor switching element 20.

Although example embodiments have been disclosed, a worker of ordinary skill in this art would recognize that certain modifications would come within the scope of the claims. For that reason, the following claims should be studied to determine their true scope and content.

What is claimed is:

1. A bus bar assembly for a power distribution system comprising:
first and second bus bars electrically isolated from one another and interconnected by a semiconductor switching element that is supported by at least one of the first and second bus bars; and
a driver logic control device in communication with the semiconductor switching element, the driver logic control device configured to drive the semiconductor element to electrically connect the first and second bus bars in response to a command.

2. The assembly according to claim 1, wherein the bus bars are aluminum, and the one of the first and second bus bars includes a copper pad secured thereto, the bare semiconductor die secured to the copper pad.

3. The assembly according to claim 1, comprising wiring extending from the semiconductor switching element to the other of the first and second bus bars.

4. The assembly according to claim 3, comprising an isolator arranged between the first and second bus bars to electrically isolate the first and second bus bars from one another, the wiring extending over the isolator.

5. The assembly according to claim 3, comprising potting material arranged over the semiconductor switching element, wiring and the one of the first and second bus bars.

6. The assembly according to claim 1, comprising a housing surrounding the first and second bus bars, and wires extending from the first and second bus bars for communicating power between an aircraft component and the housing in response to the command.

7. The assembly according to claim 6, wherein the driver logic control device is arranged within the housing in a location remote from the semiconductor switching element.

8. The assembly according to claim 1, wherein the semiconductor switching element is at least one power MOSFET.

9. The assembly according to claim 1, wherein the semiconductor switching element includes at least one TRIAC, IGTB or SCR.

10. A power distribution system for an aircraft comprising:
a power distribution box including first and second bus bars electrically isolated from one another and interconnected by a semiconductor switching element that is mounted on at least one of the first and second bus bars;
an aircraft component interconnected to the first and second bus bars by wires; and
a driver logic control device in communication with the semiconductor switching element, the driver logic control device configured to drive the semiconductor to electrically connect the first and second bus bars in response to a command to provide power to the aircraft component.

11. The system according to claim 10, wherein the driver logic control device is arranged within the housing in a location remote from the semiconductor switching element.

12. The system according to claim 10, wherein the semiconductor switching element is a bare die that is secured to one of the first and second bus bars, and comprising wiring extending from the semiconductor switching element to the other of the first and second bus bars, an isolator arranged between the first and second bus bars to electrically isolate the first and second bus bars from one another, and potting material arranged over the semiconductor switching element, the wiring, and the one of the first and second bus bars.

13. The system according to claim 12, wherein the semiconductor switching element is at least one power MOSFET.

14. The system according to claim 12, wherein the semiconductor switching element includes at least one TRIAC, IGTB or SCR.
